(19) United States
(12) Patent Application Publication
(10) Pub. No.: US 2026/0046013 A1
(43) Pub. Date: Feb. 12, 2026

(54) ANALOG EQUALIZER NETWORKS APPARATUS FOR WIDEBAND LOS-MIMO PROCESSING

(71) Applicant: POSTECH RESEARCH AND BUSINESS DEVELOPMENT FOUNDATION, Pohang-si (KR)

(72) Inventors: Ho Jin SONG, Pohang-si (KR); Sung Min CHO, Pohang-si (KR)

(73) Assignee: POSTECH RESEARCH AND BUSINESS DEVELOPMENT FOUNDATION, Pohang-si (KR)

(21) Appl. No.: 19/074,134

(22) Filed: Mar. 7, 2025

(30) Foreign Application Priority Data
Aug. 6, 2024 (KR) 10-2024-0104744

(51) Int. Cl. H04B 7/08; H04B 7/0456

(52) U.S. Cl. CPC H04B 7/0845; H04B 7/0456

(57) ABSTRACT

Disclosed is an analog equalizer network apparatus for wideband LOS-MIMO processing, the apparatus according to an embodiment including: a power distributor configured to distribute a first input signal received through a receiving antenna of a wideband LoS-MIMO network to a first path from a first input terminal to a first output terminal, and distribute a second input signal received through the receiving antenna to a second path from a second input terminal to the first output terminal; a first delay line located on the first path, and configured to delay the first input signal distributed to the first path; a second phase shifter located on the second path and configured to shift a phase of the second input signal distributed to the second path; and a power combiner configured to combine the delayed first input signal and the phase-shifted second input signal to perform channel separation.

### CROSS REFERENCE TO RELATED APPLICATION

This application claims priority to Korean Patent Application No. 10-2024-0104744 filed on Aug. 6, 2024 in Korea, the entire contents of which are hereby incorporated by reference in their entirety.

### TECHNICAL FIELD

The disclosure relates to an analog equalizer network apparatus for wideband light-of-sight (LoS)-multi-input multi-output (MIMO) processing

### BACKGROUND

With rapid increase in mobile data traffic, interest in high-frequency wireless communication capable of using a high bandwidth has recently been increasing. In particular, high data transmission rates are required in a process of transmitting data from a central data center or a core network to a base station. To this end, wired links such as optical fibers have been used. However, the costs of the wired links connecting large-scale base stations may restrict network scalability. On the other hand, wireless links may provide better scalability and flexibility at a reasonable cost, and supplement high-capacity wired links.

High-frequency wireless communication for high-capacity wireless links has a significant challenge of implementing hardware. As a frequency becomes higher, the physical performance of a semiconductor device tends to decrease, and thus a high-frequency system has low output and high noise figures. As a result, there is a limit to increasing the data transmission rates by simply utilizing a wideband. Accordingly, multiple-input multiple-output (MIMO) technology capable of space-division multiple access (SDMA) may be used to alleviate such performance requirements for the hardware.

In a band of mm/THz waves, radio waves have strong straightness, and thus mainly travel along a line-of-sight (LoS) path instead of few multiple propagation paths. In the related art, it was proven that spatial multiplexing is possible by interpreting such a propagation surface with a spherical wave. In addition, it was found that an orthogonal channel matrix is formed at a specific distance, spacing between antennas, and frequency, and the data capacity is proportional to the number of used antennas under these conditions.

When bandwidth processing is large, a sampling rate for an analog-to-digital converter (ADC) needs to increase accordingly, and thus a data converter becomes a major power consumer. Further, when an energy efficiency is taken into account, a low voltage resolution is required, but the low voltage resolution is not suitable for digital MIMO processing due to quantization noise increase and precision decrease.

Accordingly, a MIMO processing method using an analog MIMO equalizer at a receiving terminal has been proposed. However, a conventional method using only a phase shifter enables is merely capable of channel separation for a channel matrix of a single frequency. In other words, the conventional method has low signal-to-interference-plus-noise ratio (SINR) performance for wideband MIMO processing and is not suitable for wideband signal processing.

In addition, a channel matrix in an asymmetric array structure (or misalignment) is no longer a symmetric matrix. The asymmetric channel matrix causes a time delay, and the time delay needs to be compensated for to achieve the channel separation. However, a conventional phase shifter is incapable of compensating for the time delay.

### SUMMARY

Embodiments of the disclosure are to provide an analog equalizer network apparatus for wideband LoS-MIMO processing, in which an analog MIMO equalizer excellent in energy efficiency is used to enable the wideband MIMO processing suitable for wideband high-speed communication.

However, the problems to be solved in the disclosure are not limited to the foregoing, but may expand in various ways without departing from the spirit and scope of the disclosure.

According to an embodiment of the disclosure, there may be provided an analog equalizer network apparatus for wideband light-of-sight (LoS)-multi-input multi-output (MIMO) processing, the apparatus including: a power distributor configured to distribute a first input signal received through a receiving antenna of a wideband LoS-MIMO network to a first path from a first input terminal to a first output terminal, and distribute a second input signal received through the receiving antenna to a second path from a second input terminal to the first output terminal; a first delay line located on the first path, and configured to delay the first input signal distributed to the first path; a second phase shifter located on the second path and configured to shift a phase of the second input signal distributed to the second path; and a power combiner configured to combine the delayed first input signal and the phase-shifted second input signal to perform channel separation.

The first delay line may include a variable delay line for a variable delay, and a fixed delay line for a fixed delay.

The second phase shifter may include a variable phase shifter for a variable phase shift, or a fixed phase shifter for a fixed phase shift.

To enable the channel separation for all frequencies in the wideband LoS-MIMO network, a phase of a normalized channel matrix may include a component linearly dependent on the frequency and a constant component.

The linearly dependent component may be implemented by the first delay line, and the constant component may be implemented by the second phase shifter.

The apparatus may further include a second delay line for the wideband LoS-MIMO processing of an asymmetrical array, wherein the second delay line is located on the second path and configured to delay the phase-shifted second input signal so as to compensate for a time delay caused by a receiving array, and the power combiner combines the delayed first input signal and the delayed second input signal.

The apparatus may further include a first phase shifter located in front of the first delay line on the first path, and configured to shift a phase of the first input signal distributed to the first path and transmit the phase-shifted first input signal to the first delay line.

The apparatus may further include a first variable attenuator located in front of the first delay line on the first path, and configured to variably attenuate the first input signal distributed to the first path and transmit the variably attenuated first input signal to the first delay line.

The apparatus may further include a second variable attenuator located behind the second phase shifter on the second path, and configured to variably attenuate the second input signal, the phase of which has been shifted in the second phase shifter, and transmit the phase-shifted and variably-attenuated second input signal to the power combiner.

The apparatus may further include a first phase shifter located in front of the first variable attenuator on the first path, and configured to shift the phase of the first input signal distributed to the first path and transmit the phase-shifted first input signal to the first variable attenuator.

The apparatus may further include: a first variable amplifier located in front of the first delay line on the first path, and configured to variably amplify the first input signal distributed to the first path and transmit the variably amplified first input signal to the first delay line; and a second variable amplifier located behind the second phase shifter on the second path, and configured to variably amplify the second input signal, the phase of which has been shifted in the second phase shifter, and transmit the phase-shifted and variably-amplified second input signal to the power combiner.

According to another embodiment of the disclosure, there may be provided an analog equalizer network apparatus for wideband light-of-sight (LoS)-multi-input multi-output (MIMO) processing, the apparatus including: a plurality of analog equalizer networks configured to perform channel separation of input signals received through receiving antennas of N×N LOS MIMO networks, wherein each of the plurality of analog equalizer networks includes: a power distributor configured to distribute a first input signal received through the receiving antenna of the wideband LoS-MIMO network to a first path from a first input terminal to a first output terminal, and distribute a second input signal received through the receiving antenna to a second path from a second input terminal to the first output terminal; a first delay line located on the first path, and configured to delay the first input signal distributed to the first path; a second phase shifter located on the second path and configured to shift a phase of the second input signal distributed to the second path; and a power combiner configured to combine the delayed first input signal and the phase-shifted second input signal to perform channel separation.

The first delay line may include a variable delay line for a variable delay, and a fixed delay line for a fixed delay.

The second phase shifter may include a variable phase shifter for a variable phase shift, or a fixed phase shifter for a fixed phase shift.

The apparatus may further include a second delay line for the wideband LoS-MIMO processing of an asymmetrical array, wherein the second delay line is located on the second path and configured to delay the phase-shifted second input signal so as to compensate for a time delay caused by a receiving array, and the power combiner combines the delayed first input signal and the delayed second input signal.

The apparatus may further include a first phase shifter located in front of the first delay line on the first path, and configured to shift a phase of the first input signal distributed to the first path and transmit the phase-shifted first input signal to the first delay line

The apparatus may further include a first variable attenuator located in front of the first delay line on the first path, and configured to variably attenuate the first input signal distributed to the first path and transmit the variably attenuated first input signal to the first delay line.

The apparatus may further include a second variable attenuator located behind the second phase shifter on the second path, and configured to variably attenuate the second input signal, the phase of which has been shifted in the second phase shifter, and transmit the phase-shifted and variably-attenuated second input signal to the power combiner.

The apparatus may further include a first phase shifter located in front of the first variable attenuator on the first path, and configured to shift the phase of the first input signal distributed to the first path and transmit the phase-shifted first input signal to the first variable attenuator.

The apparatus may further include: a first variable amplifier located in front of the first delay line on the first path, and configured to variably amplify the first input signal distributed to the first path and transmit the variably amplified first input signal to the first delay line; and a second variable amplifier located behind the second phase shifter on the second path, and configured to variably amplify the second input signal, the phase of which has been shifted in the second phase shifter, and transmit the phase-shifted and variably-amplified second input signal to the power combiner.

### BRIEF DESCRIPTION OF THE DRAWINGS

FIG. 1 is a diagram showing the most basic 2×2 multi-input multi-output (MIMO) channel structure for light-of-sight (LoS) MIMO channels.

FIG. 2 is a diagram showing single frequency transmission signals and output signals in a 2×2 MIMO channel structure.

FIG. 3 is a diagram showing an analog network for implementing a channel separation matrix in a 2×2 MIMO channel structure.

FIG. 4 is a diagram showing an analog equalizer network apparatus for a wideband LoS-MIMO processing according to an embodiment of the disclosure.

FIG. 5 is a diagram showing the magnitudes of channel interference when using a network according to an embodiment of the disclosure and a conventional network.

FIG. 6 is a diagram showing a 2×2 MIMO channel structure having an asymmetric array of transmitting and receiving antennas.

FIG. 7 is a diagram showing an analog equalizer network apparatus for wideband LoS-MIMO processing of an asymmetrical array according to an embodiment of the disclosure.

FIGS. 8 to 18 are diagrams showing analog equalizer network apparatuses for wideband LoS-MIMO processing according to various embodiments of the disclosure.

FIG. 19 is a diagram showing a configuration of an analog equalizer network apparatus for 4×4 LoS MIMO channel separation according to another embodiment of the disclosure.

FIG. 20 is a diagram showing spectra of interference signals when using a conventional analog equalizer network and an analog equalizer network according to an embodiment of the disclosure.

### DETAILED DESCRIPTION

The disclosure may allow various kinds of change or modification and various changes in form, and specific exemplary embodiments will be illustrated in drawings and described in detail in the specification. However, it should be understood that the specific exemplary embodiments do not limit the disclosure to a specific disclosing form but include every modified, equivalent, or replaced one within the spirit and technical scope of the disclosure. In the following description, well-known functions or constructions are not described in detail since they would obscure the invention with unnecessary detail.

Although terms, such as ‘first’ and ‘second’, can be used to describe various components, the components cannot be limited by the terms. The terms can be used to classify a certain component from another component.

The terminology used in the application is used only to describe specific exemplary embodiments and does not have any intention to limit the disclosure. Although general terms as currently widely used as possible are selected as the terms used in the disclosure while taking functions in the disclosure into account, they may vary according to an intention of those of ordinary skill in the art, judicial precedents, or the appearance of new technology. In addition, in specific cases, terms intentionally selected by the applicant may be used, and in this case, the meaning of the terms will be disclosed in corresponding description of the invention. Accordingly, the terms used in the disclosure should be defined not by simple names of the terms but by the meaning of the terms and the content over the disclosure.

An expression in the singular includes an expression in the plural unless they are clearly different from each other in a context. In the disclosure, it should be understood that terms, such as ‘include’ and ‘have’, are used to indicate the existence of implemented feature, number, step, operation, component, part, or a combination of them without excluding in advance the possibility of existence or addition of one or more other features, numbers, steps, operations, components, parts, or combinations of them.

Below, embodiments of the disclosure will be described in detail with reference to the accompanying drawings, in which the same or corresponding components are assigned the same reference numerals and redundant descriptions thereof will be omitted.

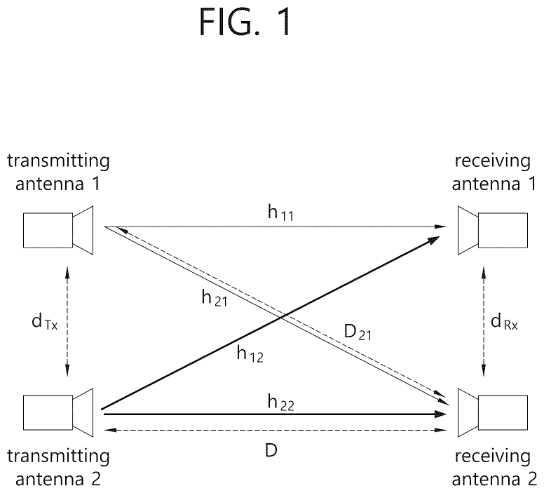

FIG. 1 is a diagram showing the most basic 2×2 multi-input multi-output (MIMO) channel structure for light-of-sight (LoS) MIMO channels.

The basic 2×2 MIMO channel structure shown in FIG. 1 includes one or more transmitting and receiving antennas (e.g., transmitting antennas 1 and 2 and receiving antennas 1 and 2), which are arranged symmetrically and equidistantly. Assuming that there are few multiple propagation paths, a LoS is a primary path. The primary path includes two paths coming from the transmitting antennas 1 and 2 in FIG. 1. Further, a distance between the transmitting and receiving antennas, i.e., a link distance D is considerably larger than an inter-antenna distance d.

Referring to a generalized expression, a LoS MIMO channel coefficient from the m^{th} transmitting antenna to the nth receiving antenna is first defined as the following [Expression 1] to derive a general LoS MIMO channel matrix.

$${h}_{mn} = \frac{c \sqrt{{G}_{t} {G}_{r}}}{4 π {D}_{mn} f} {e}^{- j 2 π \frac{{D}_{m n}}{c} f} \qquad [ Expression 1 ]$$

where, c is the speed of light, Gₜ and Gᵣ are the respective gains of the transmitting and receiving antennas, and f is the frequency of a signal. Dₘₙ is a distance from the m^{th} transmitting antenna to the nth receiving antenna. The magnitude of the channel coefficient |hₘₘ| may be derived using the Friis formula. Assuming that the link distance D is significantly larger than the antenna array distance d, the magnitude of the channel coefficient is almost constant and is approximated by the following [Expression 2].

$$H \approx \vert h \vert [ \begin{matrix}{e}^{- j 2 π \frac{{D}_{11}}{{λ}_{e}}} & {e}^{- j 2 π \frac{{D}_{12}}{{λ}_{e}}} \\ {e}^{- j 2 π \frac{{D}_{21}}{{λ}_{e}}} & {e}^{- j 2 π \frac{{D}_{22}}{{λ}_{e}}}\end{matrix} ] \qquad [ Expression 2 ]$$

Assuming that an array distance d_{Tx} between the transmitting antennas and an array distance d_{Rx} between the receiving antennas are the same d, i.e., equal to each other, and the distance D between the transmitting antenna and the receiving antenna is considerably larger than the array distance d, the magnitude of the channel coefficient is approximated by binomial approximation as in [Expression 3] and [Expression 4].

$$d ≪ D . {D}_{21} = {D}_{12} = \sqrt{{D}^{2} + {d}^{2}} = D \sqrt{1 + \frac{{d}^{2}}{{D}^{2}}} \approx D ( 1 + \frac{{d}^{2}}{2 D} ) \qquad [ Expression 3 ]$$

$$H ( f ) \approx {e}^{- j 2 π \frac{D}{c} f} [ \begin{matrix}1 & {e}^{- j \frac{π {d}^{2}}{cD} f} \\ {e}^{- j \frac{π {d}^{2}}{cD} {f}_{c}} & 1\end{matrix} ] \qquad [ Expression 4 ]$$

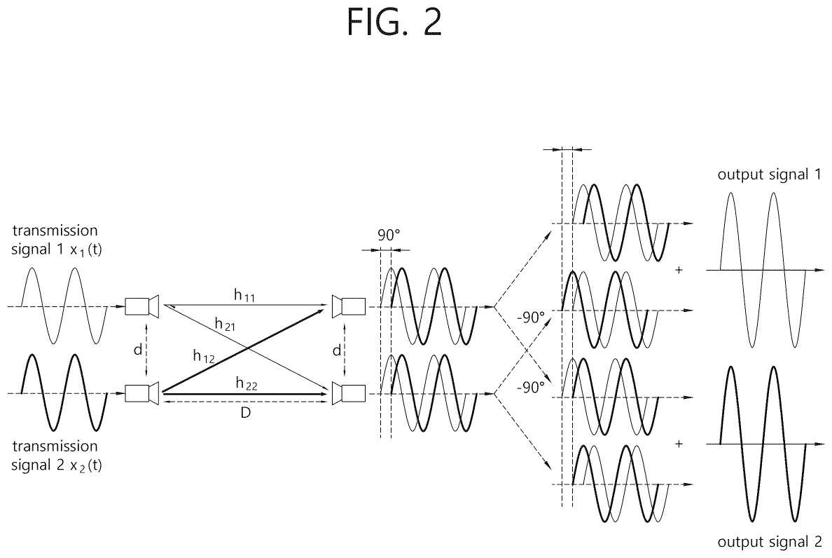

FIG. 2 is a diagram showing single frequency transmission signals and output signals in a 2×2 MIMO channel structure.

First, the single frequency may be schematized as shown in FIG. 2. A variable, i.e., a frequency f is the single frequency fc, and the normalized channel matrix is as shown in [Expression 5]. When the channel matrix is an orthogonal matrix, a spatial multiplexing gain is maximized. To this end, a condition for an optimal array distance dₒₚₜ and a channel matrix in this case are as shown in [Expression 6].

$$H ( {f}_{e} ) \approx [ \begin{matrix}1 & {e}^{- j \frac{π {d}^{2}}{cD} {f}_{c}} \\ {e}^{- j \frac{π {d}^{2}}{cD} {f}_{c}} & 1\end{matrix} ] \qquad [ Expression 5 ]$$

$$\begin{matrix}{d}_{opt} = \sqrt{\frac{cD}{2 {f}_{c}} ,} & H = [ \begin{matrix}1 & {e}^{- j \frac{π}{2}} \\ {e}^{- j \frac{π}{2}} & 1\end{matrix}\end{matrix} ] = [ \begin{matrix}1 & - j \\ - j & 1\end{matrix} ] \qquad [ Expression 6 ]$$

FIG. 2 illustrates a sinusoidal wave transmission signal before passing through the channel matrix of [Expression 6] and a reception signal after passing through the channel. Under the orthogonal channel condition, a signal arriving via a path longer than a straight path has a phase delay of 90 degrees, and overlaps a signal arriving via the straight path.

To transmit the transmission signals independently of each other, it is required to separate the overlapping signals, which will be referred to as MIMO processing or the channel separation. In the case of an orthogonal channel matrix, a matrix for the channel separation is the Hermitian matrix of the channel matrix. The process of the channel separation is as shown in FIG. 2. In FIG. 2, a phase difference between a path \textcircled{1} and a path \textcircled{2} is adjusted by −90 degrees, and the signals of the two paths are combined, thereby canceling out an undesired signal while leaving the respective transmission signals remaining.

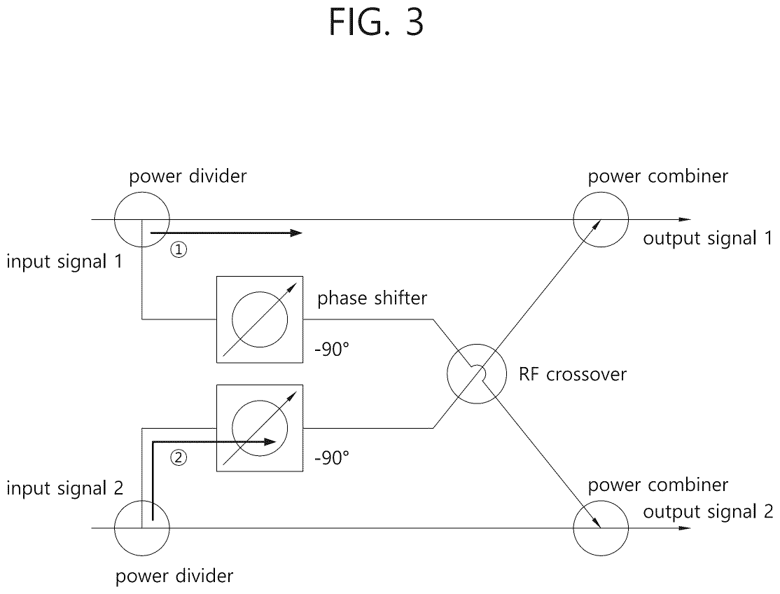

FIG. 3 is a diagram showing an analog network for implementing a channel separation matrix in a 2×2 MIMO channel structure.

To implement the channel separation matrix, the analog network may be configured as shown in FIG. 3. This network may include a phase shifter, a power distributor, and a power combiner. Here, a radio frequency (RF) crossover may serve as a crossing path where a path \textcircled{1} intersects a path \textcircled{2}. The channel separation may be implemented based on a phase difference of −90 degrees between the path \textcircled{1} and the path \textcircled{2}.

However, in actual environments, phase and amplitude imbalance may occur due to process and component differences. To compensate for such imbalance, a method of adding phase shifters and variable attenuators to all the paths may be taken into account.

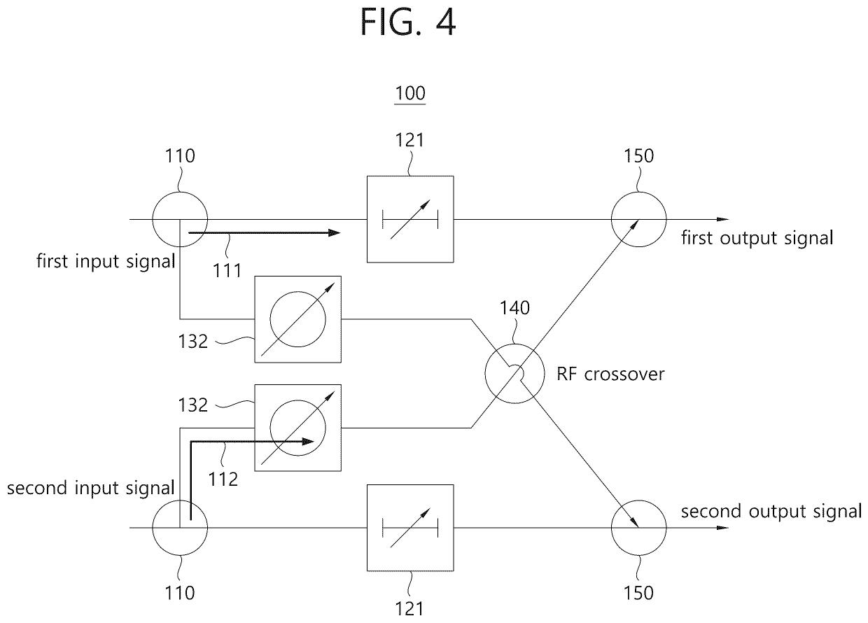

FIG. 4 is a diagram showing an analog equalizer network apparatus for a wideband LOS-MIMO processing according to an embodiment of the disclosure.

The foregoing Expressions and methods are applicable to the channel separation at the single frequency, but needs to interpret the frequency f in [Expression 4] as a variable in the case of the channel separation of a general digital modulation signal having a bandwidth. In this case, an inverse matrix of a channel matrix needs to be obtained for the channel separation, which will be referred to as channel inversion. To enable the channel separation for all the frequencies, it is required to cancel out frequency dependency, and a normalized matrix M(f) for canceling out the frequency dependency is expressed as in the following [Expression 7].

$$M ( f ) \approx [ \begin{matrix}1 & {e}^{j ( - \frac{π {d}^{2}}{cD} f + π )} \\ {e}^{j ( - \frac{π {d}^{2}}{cD} f + π )} & 1\end{matrix} ] \qquad [ Expression 7 ]$$

The phase of matrix M(f) is divided into a component linearly dependent on the frequency and a constant component. Here, the linearly dependent component may be implemented as a variable delay line, and the constant component may be implemented as a phase shifter. In other words, the analog network modified for the wideband MIMO processing may be schematized as shown in FIG. 4.

As shown in FIG. 4, the analog equalizer network apparatus 100 for the wideband LoS-MIMO processing according to an embodiment of the disclosure includes a power distributor 110, a first delay line 121, a second phase shifter 132, and a power combiner 150. However, not all of the illustrated components are essential. The analog equalizer network apparatus 100 for the wideband LoS-MIMO processing may be implemented with more components than the illustrated components, or may be implemented with fewer components than the illustrated components.

Below, the specific configurations and operations of the components in the analog equalizer network apparatus 100 for the wideband LoS-MIMO processing will be described with reference to FIG. 4.

The power distributor 110 distributes a first input signal received through the receiving antenna of the wideband LoS-MIMO network to a first path from a first input terminal to a first output terminal, and distributes a second input signal received through the receiving antenna to a second path from a second input terminal to the first output terminal.

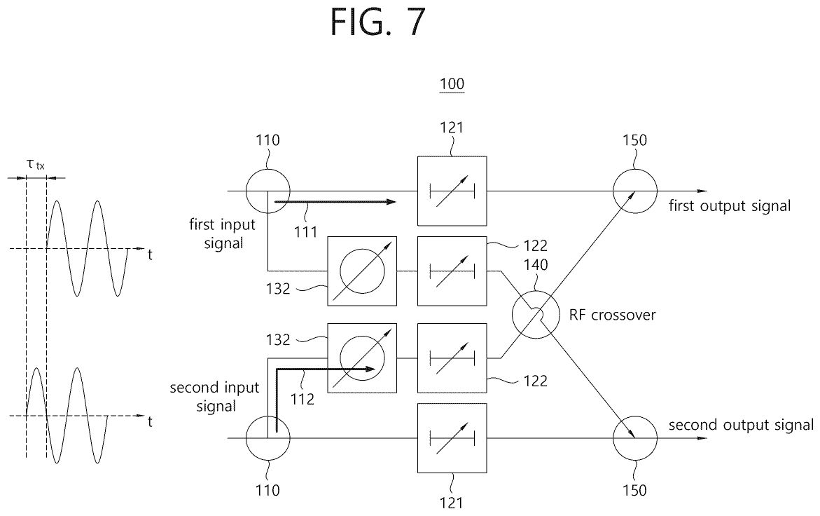

The first delay line 121 is located on the first path and delays the first input signal distributed to the first path. Here, the first delay line 121 may be a variable delay line in which the first input signal is delayed by a varied time, or a fixed delay line in which the first input signal is delayed by a fixed time. According to embodiments, at least one among a phase shifter, a variable attenuator, and a variable amplifier may be additionally located in front of the first delay line 121 on the first path. These embodiments of the disclosure will be described with reference to FIGS. 7 to 18.

The second phase shifter 132 is located on the second path and shifts the phase of the second input signal distributed to the second path. Here, the second phase shifter 132 may be a variable phase shifter that shifts the phase of the second input signal by a variable phase, or a fixed phase shifter that shifts the phase of the second input signal by a fixed phase (for example, −90°, 180°, etc.). According to embodiments, at least one of a delay line, a variable attenuator, and a variable amplifier may be additionally located behind the second phase shifter 132 on the second path. These embodiments of the disclosure will be described with reference to FIGS. 7 to 18.

The RF crossover 140 may serve as a crossing path where the first and second paths connected between the power distributor 110 and the power combiner 150 cross each other.

The power combiner 150 combines the delayed first input signal and the phase-shifted second input signal, thereby performing the channel separation.

In this way, the analog equalizer network apparatus 100 according to an embodiment of the disclosure may improve gain performance by adding an additional reciprocal network to an amplifier that is essential for a high-frequency application system.

As described above, to enable the channel separation for all the frequencies in the wideband LoS-MIMO network, the phase of the normalized channel matrix may be divided into the component linearly dependent on the frequency and the constant component.

Here, the linearly dependent component may be implemented by the first delay line 121. Further, the constant component may be implemented by the second phase shifter 132.

In FIG. 4, a phase difference ϕ between the first path 111 and the second path 112 is expressed as in the following [Expression 8].

$$ϕ = - 2 π {t}_{0} f + π \qquad [ Expression 8 ]$$

where, tₒ is a time delay caused by the variable delay line, and the time delay needed for the channel separation is as in the following [Expression 9]. The optimal array condition for a high spatial multiplexing gain is as in the [Expression 6], and simplified as follows.

$${t}_{0} = \frac{{d}^{2}}{2 cD} = \frac{1}{4 {f}_{c}} \qquad [ Expression 9 ]$$

A time delay of 1.8 ps is required when a center frequency of 140 GHz is used in the optimal array distance. A physical delay line for this time delay is very short.

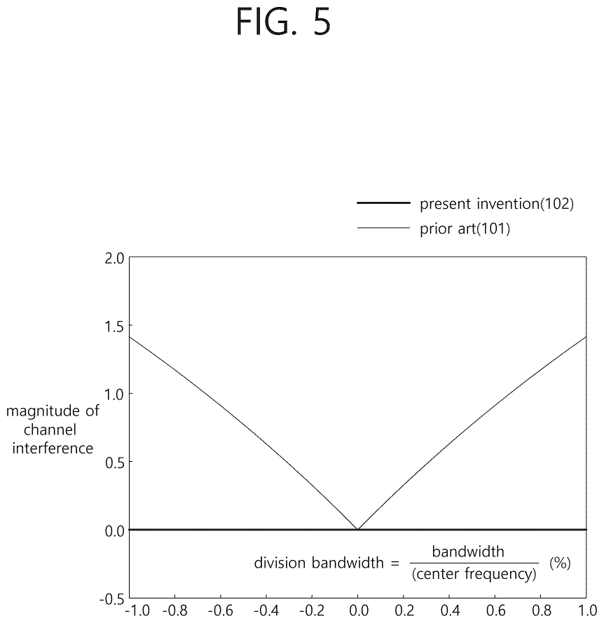

FIG. 5 is a diagram showing the magnitudes of channel interference when using a network according to an embodiment of the disclosure and a conventional network.

When the analog equalizer network apparatus 100 according to an embodiment of the disclosure and the conventional network are used for the channel separation under this condition, the magnitudes of the channel interferences over the frequency are as shown in FIG. 5.

While a conventional network method has 0 channel interference only at the single frequency, a network method according to an embodiment of the disclosure has no channel interference at all the frequencies. Further, similarly to the foregoing method, imbalance that may occur in an actual environment may be corrected by adding the delay line to all the paths.

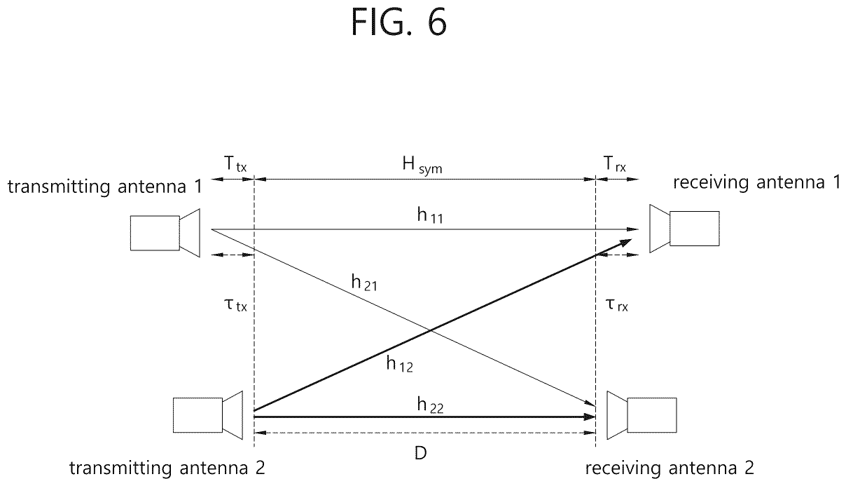

FIG. 6 is a diagram showing a 2×2 MIMO channel structure having an asymmetric array of transmitting and receiving antennas.

As shown in FIG. 6, the asymmetrical array of the transmitting and receiving antennas causes an additional time delay compared to the conventional symmetrical array. Therefore, the channel matrix of the asymmetrical array considers titled matrices Tᵣₓ and Tᵣₓ in addition to the channel matrix of the symmetrical array as shown in [Expression 10]. These matrices Tₜₓ and Tᵣₓ are expressed as diagonal matrices of time delays according to a transmitting array and a receiving array, respectively.

$${H}_{asym} \approx {T}_{rx} {H}_{sym} {T}_{tx} \qquad [ Expression 10 ]$$

$${T}_{rx} = diag ( {e}^{- j {τ}_{rx 1}} , {e}^{- j {τ}_{rx 2}} ) , {T}_{tx} = diag ( {e}^{- j {τ}_{tx 1}} , {e}^{- j {τ}_{tx 2}} ) \qquad [ Expression 11 ]$$

The channel separation of the asymmetrical array may be expressed as in the following [Expression 12]. The time delay Tₜₓ caused by the transmitting array may be compensated by the precoding or time delay line at a transmitting terminal. The channel matrix of the symmetrical array may be canceled by a proposed method. Further, as shown in FIG. 7, the time delay Tᵣₓ caused by the receiving array may be compensated by adjusting the time delay of the first input signal and the second input signal.

$$Y = {( {T}_{rx} {H}_{sym} )}^{- 1} {T}_{rx} {H}_{sym} {T}_{tx} ( {T}_{tx}^{- 1} x ) + n \qquad [ Expression 12 ]$$

Here, Tₜₓ⁻¹x may be implemented by the precoding or delay line at the transmitting terminal, and (TᵣₓH_{sym})⁻¹ may be implemented by the network according to an embodiment of the disclosure at the receiving terminal.

FIG. 7 is a diagram showing an analog equalizer network apparatus for wideband LOS-MIMO processing of an asymmetrical array according to an embodiment of the disclosure.

As shown in FIG. 7, the analog equalizer network apparatus 100 for the wideband LoS-MIMO processing of the asymmetrical array according to an embodiment of the disclosure includes the power distributor 110, the first delay line 121, a second delay line 122, the second phase shifter 132, and the power combiner 150.

Below, FIG. 7 describes the specific configuration and operation of each component of the analog equalizer network apparatus 100 for the wideband LoS-MIMO processing in the asymmetrical array.

Below, the specific configurations and operations of the components in the analog equalizer network apparatus 100 for the wideband LoS-MIMO processing in the asymmetrical array will be described with reference to FIG. 7.

The power distributor 110 distributes the first input signal received through the receiving antenna of the wideband LoS-MIMO network to the first path, and distributes the second input signal to the second path.

The first delay line 121 is located on the first path and serves as the variable delay line. The first delay line 121 variably delays the first input signal distributed to the first path.

The second phase shifter 132 is located behind the second delay line 122 on the second path, and shifts the phase of the second input signal distributed to the second path.

The second delay line 122 is for the wideband LoS-MIMO processing of the asymmetrical array. The second delay line 122 is located on the second path and serves as the variable delay line. The second delay line 122 variably delays the second input signal, the phase of which has been shifted by the second phase shifter 132, to compensate for the time delay caused by the receiving array.

The RF crossover 140 may serve as a crossing path where the first and second paths connected between the power distributor 110 and the power combiner 150 cross each other.

The power combiner 150 combines the variably delayed first input signal and the phase-shifted and variably delayed second input signal, thereby performing the channel separation. Further, the power combiner 150 combines the delayed first input signal and the delayed second input signal, thereby performing the channel separation.

As described above, to enable the channel separation for all the frequencies in the wideband LoS-MIMO network, the phase of the normalized channel matrix can be composed of the linearly dependent component and the constant component for the frequency.

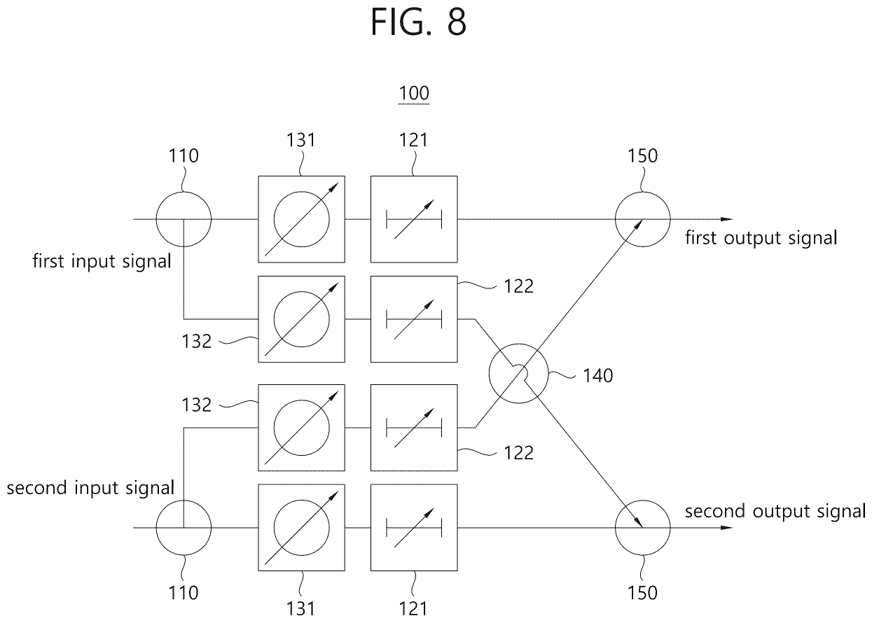

FIGS. 8 to 18 are diagrams showing analog equalizer network apparatuses for wideband LOS-MIMO processing according to various embodiments of the disclosure.

In various embodiments of the disclosure capable of the channel separation, analog signal processing is performed using at least one among the phase shifter, the delay line, the variable attenuator, and the variable amplifier. Below, the embodiments of the disclosure will be described with reference to FIGS. 8 to 18.

As shown in FIG. 8, the analog equalizer network apparatus 100 for the wideband LoS-MIMO processing according to the embodiments of the disclosure includes the power distributor 110, the first delay line 121, the second delay line 122, a first phase shifter 131, the second phase shifter 132, and the power combiner 150.

Below, the specific configurations and operations of the components in the analog equalizer network apparatus 100 for the wideband LoS-MIMO processing will be described with reference to FIG. 8.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first phase shifter 131 is located in front of the first delay line 121 on the first path, shifts the phase of the first input signal distributed to the first path and transmits it to the first delay line 121.

The first delay line 121 is located behind the first phase shifter 131 on the first path and serves as the variable delay line. The first delay line 121 variably delays the first input signal, the phase of which has been shifted by the first phase shifter 131, and transmits it to the power combiner 150.

The second phase shifter 132 is located in front of the second delay line 122 on the second path, shifts the phase of the second input signal distributed to the second path and transmits it to the second delay line 122.

The second delay line 122 is located behind the second phase shifter 132 on the second path and serves as the variable delay line. The second delay line 122 variably delays the second input signal, the phase of which has been shifted by the second phase shifter 132, and transmits it to the power combiner 150.

The RF crossover 140 may serve as a crossing path where the first and second paths connected between the power distributor 110 and the power combiner 150 cross each other.

The power combiner 150 combines the phase-shifted and variably-delayed first input signal and the phase-shifted and variably-delayed second input signal, thereby performing the channel separation.

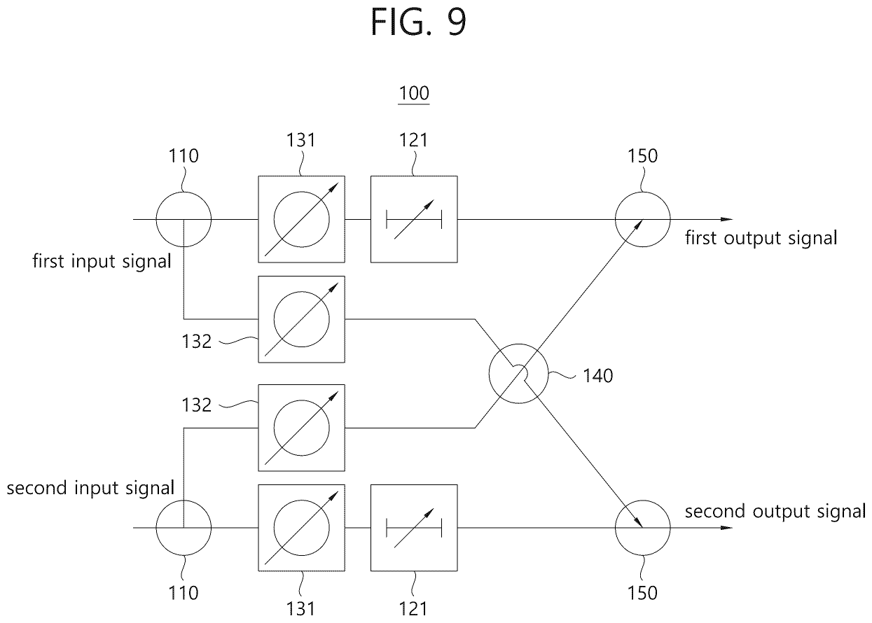

Meanwhile, as shown in FIG. 9, the analog equalizer network apparatus 100 for the wideband LoS-MIMO processing according to the embodiments of the disclosure includes the power distributor 110, the first delay line 121, the first phase shifter 131, the second phase shifter 132, and the power combiner 150.

Below, the specific configurations and operations of the components in the analog equalizer network apparatus 100 for the wideband LoS-MIMO processing will be described with reference to FIG. 9.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first phase shifter 131 is located in front of the first delay line 121 on the first path, shifts the phase of the first input signal distributed to the first path and transmits it to the first delay line 121.

The first delay line 121 is located behind the first phase shifter 131 on the first path and serves as the variable delay line. The first delay line 121 variably delays the first input signal, the phase of which has been shifted by the first phase shifter 131, and transmits it to the power combiner 150.

The second phase shifter 132 is located on the second path, and shifts the phase of the second input signal distributed to the second path and transmits it to the power combiner 150.

Here, the first phase shifter 131 and the second phase shifter 132 may control a constant of the phase difference. However, an actual phase shifter may have a time delay. Therefore, it is necessary to compensate for the time delay.

As above, the analog equalizer network apparatus 100 may add the first phase shifter 131 and the second phase shifter 132 to all the paths, thereby equalizing the time delay between the paths.

The RF crossover 140 may serve as a crossing path where the first and second paths connected between the power distributor 110 and the power combiner 150 cross each other.

The power combiner 150 may combine the phase-shifted and variably-delayed first input signal and the phase-shifted second input signal, thereby performing the channel separation.

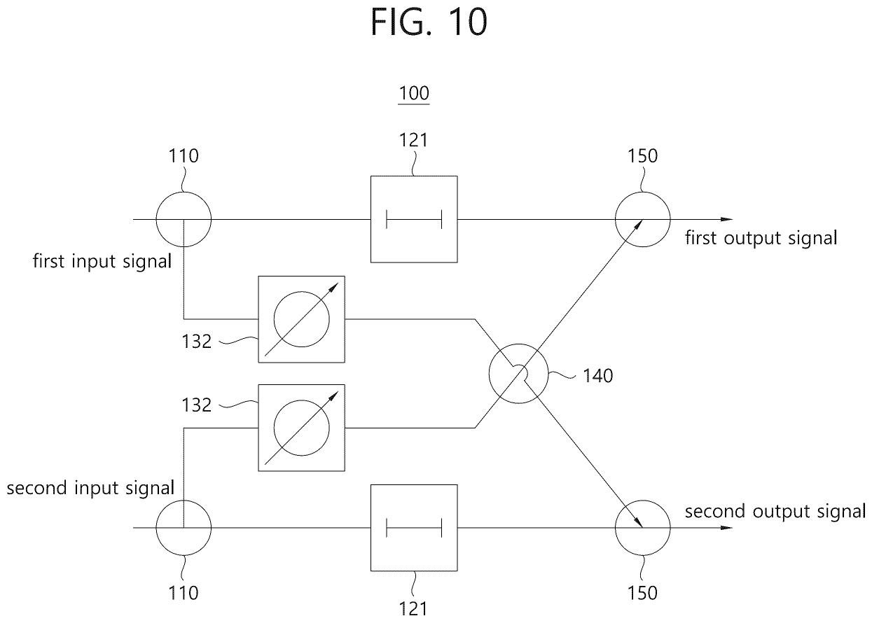

Meanwhile, as shown in FIG. 10, the analog equalizer network apparatus 100 for the wideband LoS-MIMO processing according to the embodiments of the disclosure includes the power distributor 110, the first delay line 121, the second phase shifter 132, and the power combiner 150.

Below, the specific configurations and operations of the components in the analog equalizer network apparatus 100 for the wideband LoS-MIMO processing will be described with reference to FIG. 10.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first delay line 121 is located on the first path and serves as the fixed delay line. The first delay line 121 delays the first input signal distributed from the power distributor 110 by the fixed time, and transmits it to the power combiner 150.

The second phase shifter 132 is located on the second path, and shifts the phase of the second input signal distributed to the second path and transmits it to the power combiner 150.

The RF crossover 140 may serve as a crossing path where the first and second paths connected between the power distributor 110 and the power combiner 150 cross each other.

The power combiner 150 combines the fixedly-delayed first input signal and the phase-shifted second input signal, thereby performing the channel separation.

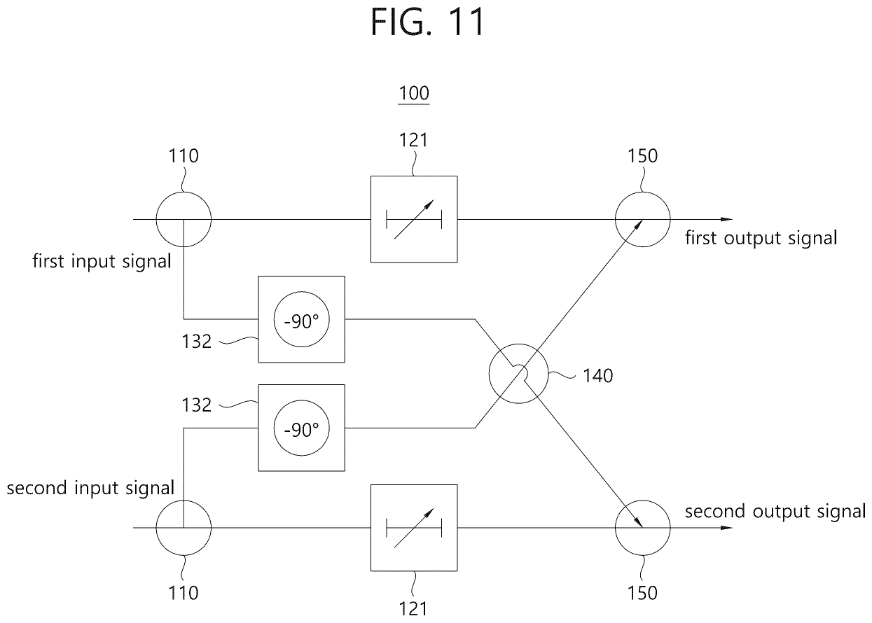

Meanwhile, as shown in FIG. 11, the analog equalizer network apparatus 100 for the wideband LoS-MIMO processing according to the embodiments of the disclosure includes the power distributor 110, the first delay line 121, the second phase shifter 132, and the power combiner 150.

Below, the specific configurations and operations of the components in the analog equalizer network apparatus 100 for the wideband LoS-MIMO processing will be described with reference to FIG. 11.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first delay line 121 is located on the first path and serves as the variable delay line. The first delay line 121 variably delays the first input signal distributed from the power distributor 110, and transmits it to the power combiner 150.

The second phase shifter 132 is located on the second path and serves as a fixed phase shifter that shifts the phase by a fixed phase. The second phase shifter 132 shifts the phase of the second input signal distributed to the second path by a fixed phase of −90° and transmits it to the power combiner 150.

The RF crossover 140 may serve as a crossing path where the first and second paths connected between the power distributor 110 and the power combiner 150 cross each other.

The power combiner 150 combines the variably-delayed first input signal and the second input signal, the phase of which has been shifted by the fixed phase, thereby performing the channel separation.

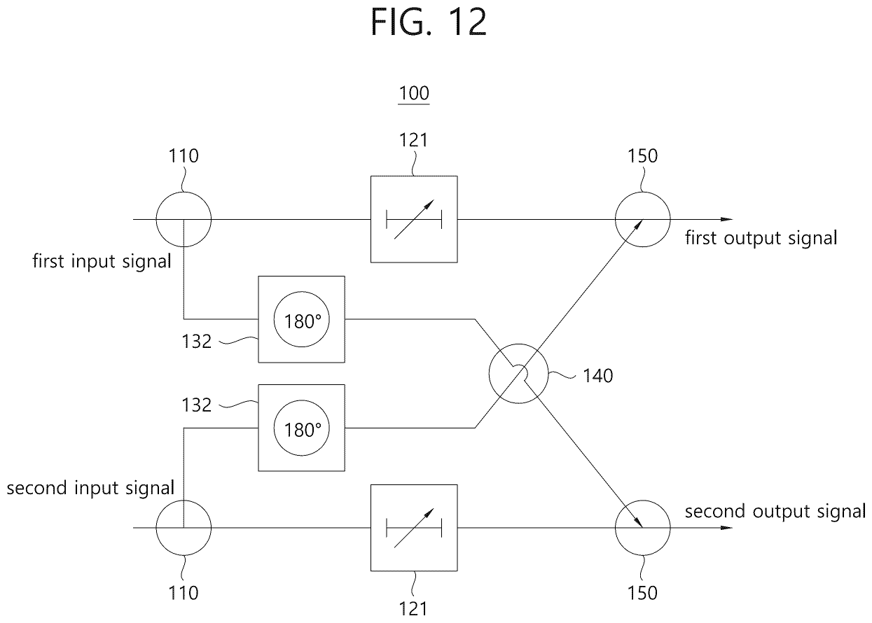

Meanwhile, as shown in FIG. 12, the analog equalizer network apparatus 100 for the wideband LoS-MIMO processing according to the embodiments of the disclosure includes the power distributor 110, the first delay line 121, the second phase shifter 132, and the power combiner 150.

Below, the specific configurations and operations of the components in the analog equalizer network apparatus 100 for the wideband LoS-MIMO processing will be described with reference to FIG. 12.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first delay line 121 is located on the first path and serves as the variable delay line. The first delay line 121 delays the first input signal distributed from the power distributor 110 by a varied time, and transmits it to the power combiner 150.

The second phase shifter 132 is located on the second path and serves as a fixed phase shifter that shifts the phase by a fixed phase. The second phase shifter 132 shifts the phase of the second input signal distributed to the second path by a fixed phase of −180° and transmits it to the power combiner 150.

Here, the phase difference required between the first path and the second path is π(180°), and thus the analog equalizer network apparatus 100 uses the invariable second phase shifter 132 to perform the channel separation.

The RF crossover 140 may serve as a crossing path where the first and second paths connected between the power distributor 110 and the power combiner 150 cross each other.

The power combiner 150 combines the variably-delayed first input signal and the second input signal, the phase of which has been shifted by the fixed phase, thereby performing the channel separation.

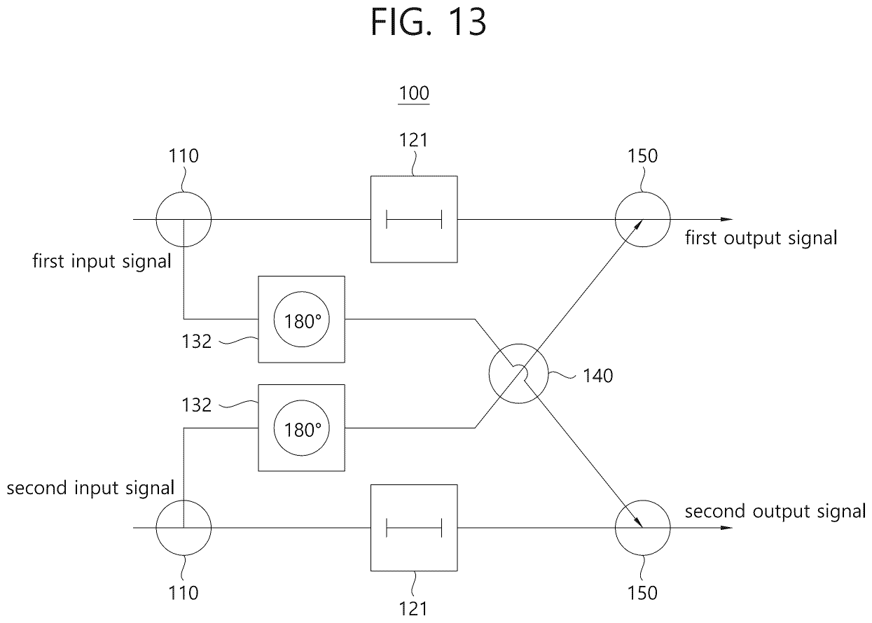

Meanwhile, as shown in FIG. 13, the analog equalizer network apparatus 100 for the wideband LoS-MIMO processing according to the embodiments of the disclosure includes the power distributor 110, the first delay line 121, the second phase shifter 132, and the power combiner 150.

Below, the specific configurations and operations of the components in the analog equalizer network apparatus 100 for the wideband LoS-MIMO processing will be described with reference to FIG. 13.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first delay line 121 is located on the first path and serves as the fixed delay line. The first delay line 121 delays the first input signal distributed from the power distributor 110 by a fixed time, and transmits it to the power combiner 150.

The second phase shifter 132 is located on the second path and serves as a fixed phase shifter that shifts the phase by a fixed phase. The second phase shifter 132 shifts the phase of the second input signal distributed to the second path by a fixed phase of −180° and transmits it to the power combiner 150.

Here, as shown in [Expression 9], the fixed time delay to of the first delay line 121 varies depending on the inter-antenna distance d and the link distance D. When the time delay is fixed, the analog equalizer network apparatus 100 uses the first delay line 121 serving as the fixed delay line, thereby performing the channel separation.

The RF crossover 140 may serve as a crossing path where the first and second paths connected between the power distributor 110 and the power combiner 150 cross each other.

The power combiner 150 combines the fixedly-delayed first input signal and the second input signal, the phase of which has been shifted by the fixed phase, thereby performing the channel separation.

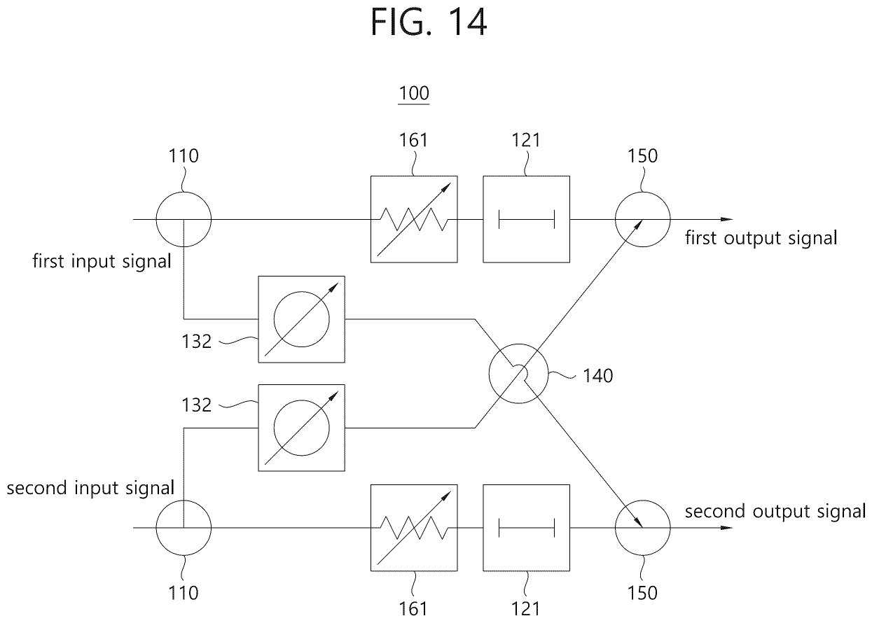

Meanwhile, as shown in FIG. 14, the analog equalizer network apparatus 100 for the wideband LoS-MIMO processing according to the embodiments of the disclosure includes the power distributor 110, the first delay line 121, the second phase shifter 132, the power combiner 150, and a first attenuator 161.

Below, the specific configurations and operations of the components in the analog equalizer network apparatus 100 for the wideband LoS-MIMO processing will be described with reference to FIG. 14.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first variable attenuator 161 is located in front of the first delay line 121 on the first path, and variably attenuates the first input signal distributed from the power distributor 110.

The first delay line 121 is located behind the first variable attenuator 161 on the first path, and serves as the fixed delay line. The first variable attenuator 161 delays the variably attenuated first input signal by the fixed time, and transmits it to the power combiner 150.

The second phase shifter 132 is located on the second path, and shifts the phase of the second input signal distributed to the second path and transmits it to the power combiner 150.

The RF crossover 140 may serve as a crossing path where the first and second paths connected between the power distributor 110 and the power combiner 150 cross each other.

The power combiner 150 combines the variably-attenuated and fixedly-delayed first input signal and the phase-shifted second input signal, thereby performing the channel separation.

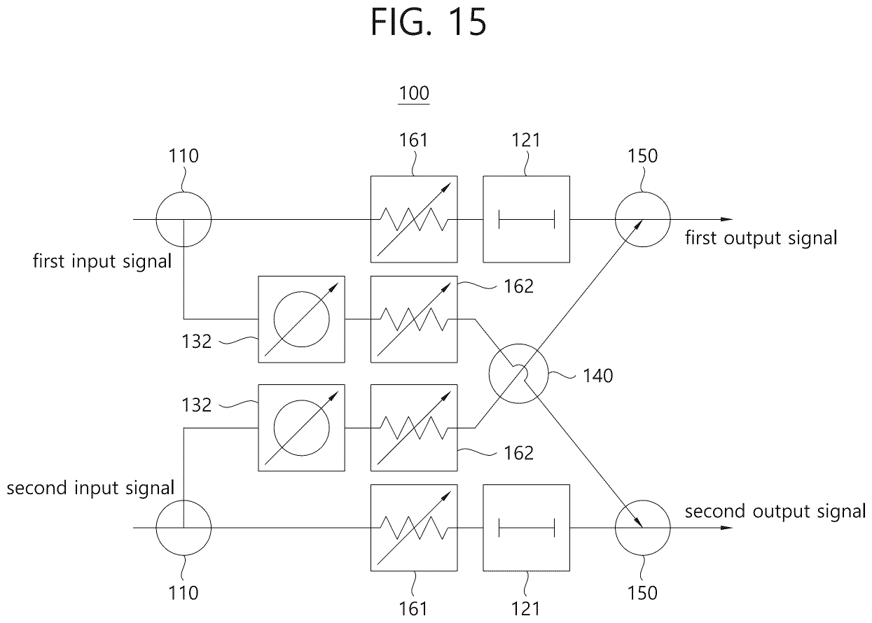

Meanwhile, as shown in FIG. 15, the analog equalizer network apparatus 100 for the wideband LoS-MIMO processing according to the embodiments of the disclosure includes the power distributor 110, the first delay line 121, the second phase shifter 132, the power combiner 150, the first attenuator 161, and a second attenuator 162.

Below, the specific configurations and operations of the components in the analog equalizer network apparatus 100 for the wideband LoS-MIMO processing will be described with reference to FIG. 15.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first variable attenuator 161 is located in front of the first delay line 121 on the first path, and variably attenuates the first input signal distributed from the power distributor 110.

The first delay line 121 is located behind the first variable attenuator 161 on the first path, and serves as the fixed delay line. The first variable attenuator 161 delays the variably attenuated first input signal by the fixed time, and transmits it to the power combiner 150.

The second phase shifter 132 is located in front of the second variable attenuator 162 on the second path, shifts the phase of the second input signal distributed to the second path, and transmits it to the second variable attenuator 162.

The second variable attenuator 162 is located behind the second phase shifter 132 on the first path, and variably attenuates the second input signal, the phase of which has been shifted by the second phase shifter 132.

The RF crossover 140 may serve as a crossing path where the first and second paths connected between the power distributor 110 and the power combiner 150 cross each other.

The power combiner 150 combines the variably-attenuated and fixedly-delayed first input signal and the phase-shifted and variably-attenuated second input signal, thereby performing the channel separation.

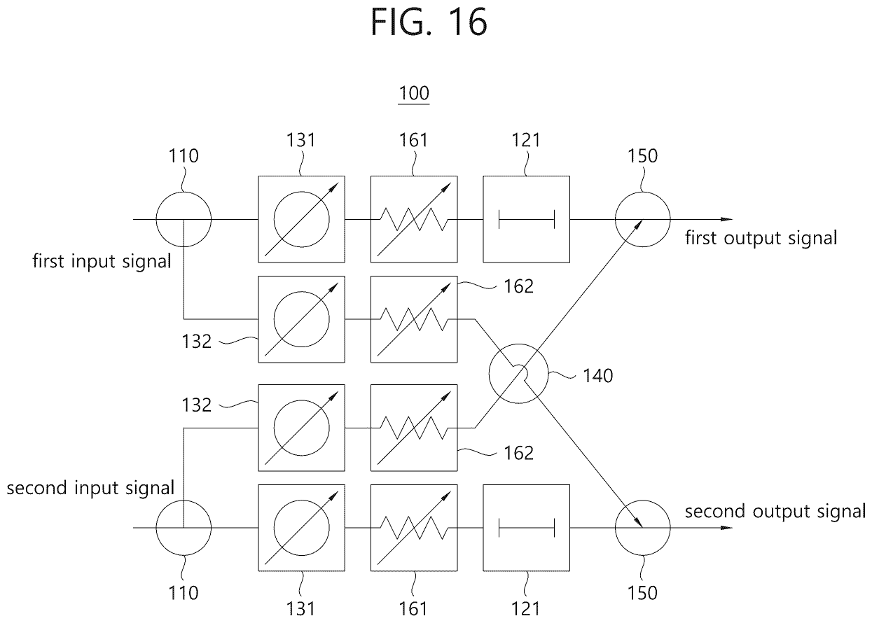

Meanwhile, as shown in FIG. 16, the analog equalizer network apparatus 100 for the wideband LoS-MIMO processing according to the embodiments of the disclosure includes the power distributor 110, the first delay line 121, the first phase shifter 131, the second phase shifter 132, the power combiner 150, the first attenuator 161, and a second attenuator 162.

Below, the specific configurations and operations of the components in the analog equalizer network apparatus 100 for the wideband LoS-MIMO processing will be described with reference to FIG. 16.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first phase shifter 131 is located in front of the first variable attenuator 161 on the first path, shifts the phase of the first input signal distributed to the first path, and transmits it to the first variable attenuator 161.

The first variable attenuator 161 is located behind the first phase shifter 131 on the first path, and variably attenuates the first input signal, the phase of which has been shifted by the first phase shifter 131.

The first delay line 121 is located behind the first variable attenuator 161 on the first path, and serves as the fixed delay line. The first delay line 121 delays the first input signal, which has been variably attenuated in the first variable attenuator 161, by the fixed time, and transmits it to the power combiner 150.

The second phase shifter 132 is located in front of the second variable attenuator 162 on the second path, shifts the phase of the second input signal distributed to the second path, and transmits it to the second variable attenuator 162.

The second variable attenuator 162 is located behind the second phase shifter 132 on the first path, and variably attenuates the second input signal, the phase of which has been shifted in the second phase shifter 132.

The RF crossover 140 may serve as a crossing path where the first and second paths connected between the power distributor 110 and the power combiner 150 cross each other.

The power combiner 150 combines the phase-shifted, variably-attenuated and fixedly-delayed first input signal and the phase-shifted and variably-attenuated second input signal, thereby performing the channel separation.

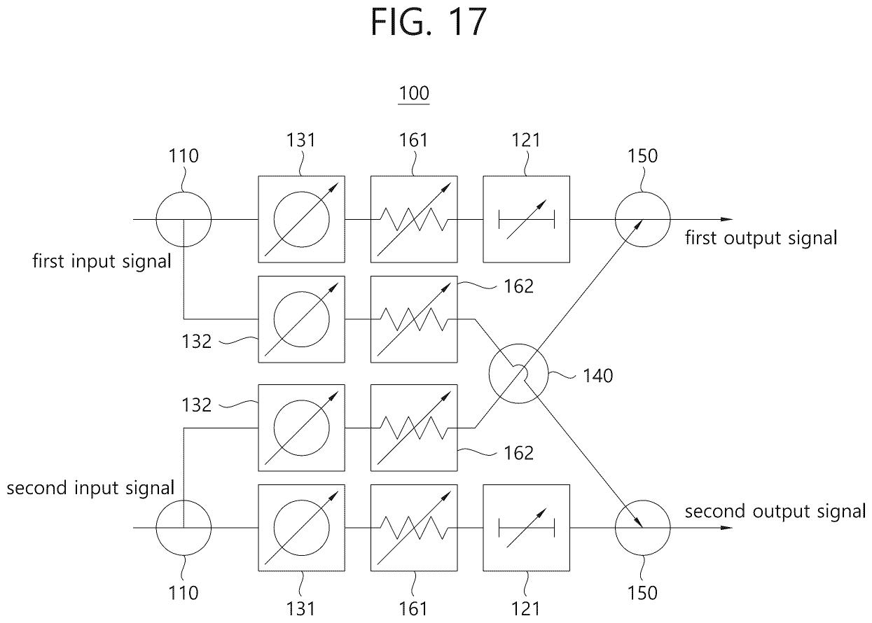

Meanwhile, as shown in FIG. 17, the analog equalizer network apparatus 100 for the wideband LoS-MIMO processing according to the embodiments of the disclosure includes the power distributor 110, the first delay line 121, the first phase shifter 131, the second phase shifter 132, the power combiner 150, the first attenuator 161, and a second attenuator 162.

Below, the specific configurations and operations of the components in the analog equalizer network apparatus 100 for the wideband LoS-MIMO processing will be described with reference to FIG. 17.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first phase shifter 131 is located in front of the first variable attenuator 161 on the first path, shifts the phase of the first input signal distributed to the first path, and transmits it to the first variable attenuator 161.

The first variable attenuator 161 is located behind the first phase shifter 131 on the first path, and variably attenuates the first input signal, the phase of which has been shifted in the first phase shifter 131.

The first delay line 121 is located behind the first variable attenuator 161 on the first path, and serves as the variable delay line. The first delay line 121 variably delays the first input signal, which has been variably attenuated in the first variable attenuator 161, by a varied time, and transmits it to the power combiner 150.

The second phase shifter 132 is located in front of the second variable attenuator 162 on the second path, shifts the phase of the second input signal distributed to the second path, and transmits it to the second variable attenuator 162.

The second variable attenuator 162 is located behind the second phase shifter 132 on the first path, and variably attenuates the second input signal, the phase of which has been shifted by the second phase shifter 132.

The RF crossover 140 may serve as a crossing path where the first and second paths connected between the power distributor 110 and the power combiner 150 cross each other.

The power combiner 150 combines the phase-shifted, variably-attenuated and variably-delayed first input signal and the phase-shifted and variably-attenuated second input signal, thereby performing the channel separation.

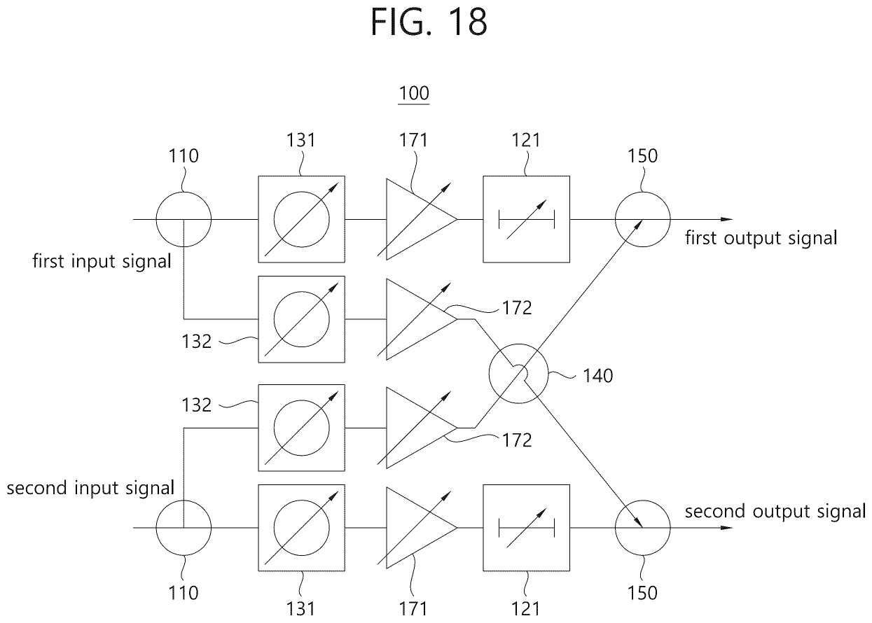

Meanwhile, as shown in FIG. 18, the analog equalizer network apparatus 100 for the wideband LoS-MIMO processing according to the embodiments of the disclosure includes the power distributor 110, the first delay line 121, the first phase shifter 131, the second phase shifter 132, the power combiner 150, a first amplifier 171, and a second amplifier 172.

Below, the specific configurations and operations of the components in the analog equalizer network apparatus 100 for the wideband LoS-MIMO processing will be described with reference to FIG. 18.

The power distributor 110 distributes the first input signal received through the receiving antenna of the wideband LoS-MIMO network to the first path from the first input terminal to the first output terminal, and distributes the second input signal received through the receiving antenna to the second path from the second input terminal to the first output terminal.

The first phase shifter 131 is located in front of the first variable amplifier 171 on the first path, shifts the phase of the first input signal distributed to the first path, and transmits it to the first variable amplifier 171.

The first variable amplifier 171 is located behind the first phase shifter 131 on the first path, and variably amplifies the first input signal, the phase of which has been shifted by the first phase shifter 131.

The first delay line 121 is located behind the first variable amplifier 171 on the first path, and serves as the variable delay line. The first delay line 121 variably delays the first input signal, which has been variably amplified in the first variable amplifier 171, by a varied time, and transmits it to the power combiner 150.

The second phase shifter 132 is located in front of the second variable amplifier 172 on the second path, shifts the phase of the second input signal distributed to the second path, and transmits it to the second variable amplifier 172.

The second variable amplifier 172 is located behind the second phase shifter 132 on the first path, and variably amplifies the second input signal, the phase of which has been shifted in the second phase shifter 132.

The RF crossover 140 may serve as a crossing path where the first and second paths connected between the power distributor 110 and the power combiner 150 cross each other.

The power combiner 150 combines the phase-shifted, variably-amplified and variably-delayed first input signal and the phase-shifted and variably-amplified second input signal, thereby performing the channel separation.

Here, the LoS MIMO channel matrix is approximated like [Expression 1] and the matrix shown in [Expression 2]. However, in reality, amplitude imbalance may occur according to antenna frequency, imbalance between components, etc. To compensate for the amplitude imbalance, the analog equalizer network apparatus 100 may use the first variable attenuator 161 and the second variable attenuator 162 or the first variable amplifier 171 and the second variable amplifier 172 as shown in FIGS. 15 to 18, thereby compensating for the amplitude imbalance.

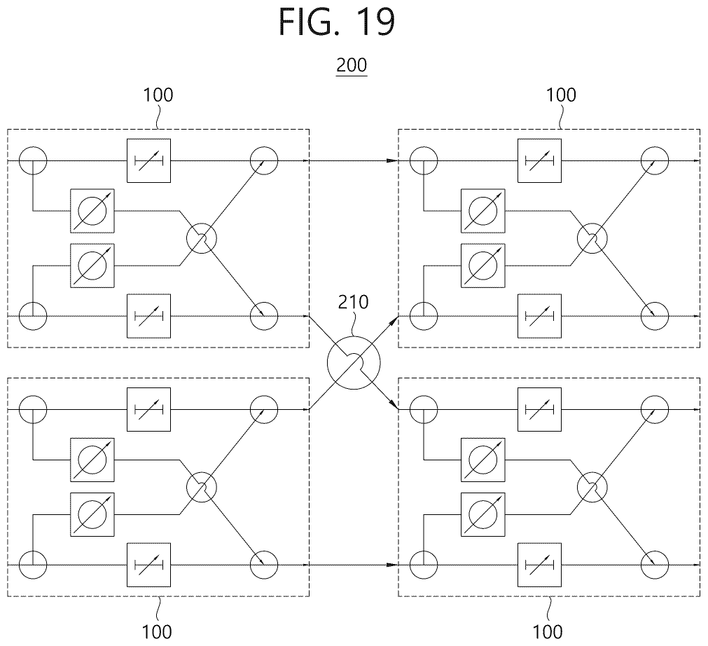

FIG. 19 is a diagram showing a configuration of an analog equalizer network apparatus for 4×4 LoS MIMO channel separation according to another embodiment of the disclosure.

According to an embodiment of the disclosure, the analog equalizer network apparatus for the channel separation of a 2×2 network may be arranged as shown in FIG. 19 to configure an analog equalizer network apparatus 200 for the channel separation of a 4×4 network.

To this end, the analog equalizer network apparatus 200 according to this embodiment of the disclosure may further include an RF crossover 210 that serves as a crossing path where paths between the analog equalizer network apparatuses for the channel separation of the respective 2×2 networks cross each other.

Here, the analog equalizer network apparatus 100 included in the analog equalizer network apparatus 200 according to this embodiment of the disclosure may be configured based on any one of the embodiments for the analog equalizer network apparatus 100 shown in FIGS. 4 and 7 to FIG. 18. Further, the analog equalizer network apparatus 100 is not limited to the analog equalizer network apparatus having a specific structure but may be configured as an analog equalizer network apparatus capable of the channel separation.

Such a method is based on the principle similar to the radix operation or butterfly operation used in fast Fourier transform (FFT). According to this embodiment of the disclosure, the 2×2 network is expanded to the 4×4 network in this way, thereby more efficiently separating and processing the multiple channels. Here, the 4×4 network is merely an example, and the 2×2 network may be expanded up to an N×N network, where N is not limited to a specific number. The analog equalizer network apparatus according to this embodiment of the disclosure may play an important role in improving the efficiency and capacity of the wideband data transmission in the communication system.

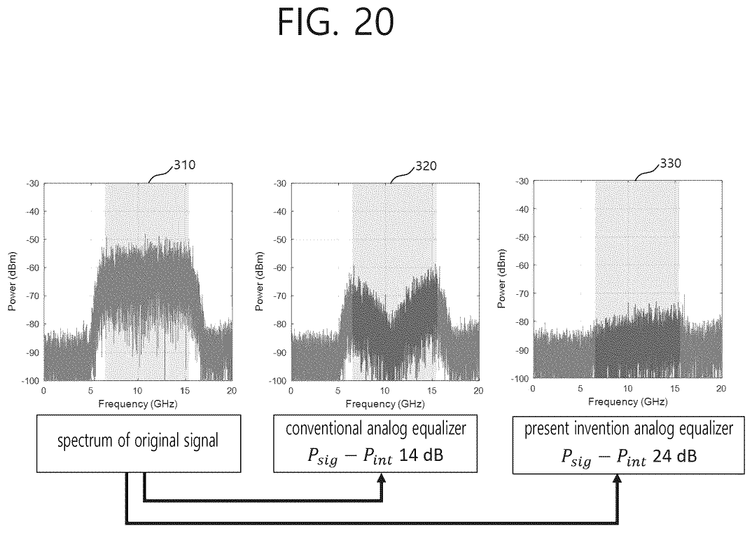

FIG. 20 is a diagram showing spectra of interference signals when using a conventional analog equalizer network and an analog equalizer network according to an embodiment of the disclosure.

FIG. 20 shows experiment results for comparison between the conventional analog equalizer network and the analog equalizer network according to the embodiments of the disclosure under specific conditions and environments, and the embodiments of the disclosure are not limited to those specific conditions and environments shown in FIG. 20. The systems according to the embodiments of the disclosure may be applied to all the frequencies. Further, a noise floor level may vary depending on the performance of observation equipment (e.g., a spectrum analyzer) used in the experiments, and may be a performance indicator unrelated to the embodiments of the disclosure.

The left graph 310 in FIG. 20 shows an original signal spectrum. In the original signal spectrum, the interference signal appears large in a wideband.

The central graph 320 in FIG. 20 shows an interference signal spectrum when the conventional analog equalizer network is used. Compared to the original signal spectrum, the shape of the spectrum shows that the interference signal is reduced or suppressed only in a specific band.

The right graph 330 in FIG. 20 shows an interference signal spectrum when the analog equalizer network according to an embodiment of the disclosure is used. The right graph 330 shows that the interference signal is suppressed more evenly overall compared to the central graph 320. This suggests that the analog equalizer network according to an embodiment of the disclosure contributes to suppressing the interference signal more effectively.

While the conventional analog equalizer network could only limitedly suppress the interference signal, the analog equalizer network apparatus 100 according to an embodiment of the disclosure can maintain the interference signal at a uniformly low level throughout the band. Such improvement in the analog equalizer network apparatus 100 according to an embodiment of the disclosure can provide better signal quality and better interference cancellation performance.

The disclosure may have the following effects. However, this does not mean that a specific embodiment should include all or only the following effects, and thus the scope of the disclosure should not be construed as being limited by the following effects.

According to the embodiments of the disclosure, the wideband MIMO channel separation is performed through the analog signal processing based on at least one among the phase shifter, the delay line, the variable attenuator, and the variable amplifier, thereby solving the energy consumption problem of the analog-digital converter (ADC), which is one of the major bottlenecks in the wideband MIMO signal processing.

The embodiments of the disclosure take the frequency-dependent channel matrix into account and are thus applicable even to the wideband signal processing through simple modification to the conventional analog network. In other words, the embodiments of the disclosure provide the wideband high-speed data transmission without significantly increasing power consumption and system complexity, which are important considerations in implementing an actual system.

It was difficult for a conventional network structure to solve the problems such as the amplitude and phase imbalance, the asymmetrical array, and the like that may occur in actual environments, but the embodiments of the disclosure can solve the problems such as the amplitude and phase imbalance, the asymmetrical array and the like through the variable delay line located in each path.

Increasing the number of MIMO channels to achieve higher data transmission rates increases the complexity of the network. According to the embodiments of the disclosure, a simple FFT algorithm may be used to decompose a complex network into basic networks. This helps to reduce the complexity of the implementation while maintaining the scalability of the network.

Meanwhile, according to an embodiment of the present invention, various embodiments described above may be implemented with software including commands stored in machine-readable storage media that can be read by a machine (e.g., a computer). The device refers to a device capable of calling the stored command from the storage medium and operating based on the called command, and may include an electronic device (e.g., an electronic device (A)) according to the disclosed embodiments. When the command is executed by a processor, the processor may perform a function corresponding to the command by using other components directly or under the control of the processor. The command may include a code generated or executed by a compiler or an interpreter. The device-readable storage medium may be provided in the form of a non-transitory storage medium. Here, ‘non-transitory’ means that the storage medium does not contain a signal and is tangible, but does not distinguish whether data is stored semi-permanently or temporarily in the storage medium.

Further, according to an embodiment of the disclosure, the method according to various embodiments described above may be provided as included in a computer program product. The computer program product may be traded between a seller and a buyer as a commodity. The computer program product may be distributed online in the form of the device-readable storage medium readable by a device (e.g., compact disc read only memory (CD-ROM)), or through an application store (e.g., Play Store™). In the case of online distribution, at least a part of the computer program product may be temporarily stored or temporarily generated in the storage medium such as the memory of a manufacturer's server, an application store's server, or a relay server.

Further, according to an embodiment of the disclosure, various embodiments described above may be implemented in a computer or similar device-readable recording medium using software, hardware or a combination thereof. In some cases, the embodiments described herein may be implemented in the processor itself. In the case of software implementation, the embodiments described herein, such as the procedures and functions, may be implemented as separate software modules. Each of the software modules may perform one or more functions and operations described herein.

Meanwhile, computer instructions for performing processing operations of a device according to various embodiments described above may be stored in a non-transitory computer-readable medium. The computer instructions stored in the non-transitory computer-readable medium cause a specific device to perform processing operations in the device according to various embodiments described above, when executed by the processor of the specific device. The non-transitory computer-readable medium is not a medium that stores data for a short period of time like a register, cache, or a memory, but a medium that permanently stores data to be readable by the device. Specific examples of the non-transitory computer-readable media include CDs, DVDs, hard disks, Blu-ray disks, USBs, memory cards, and ROMs.

Further, each of the components (e.g., the modules or the programs) according to various embodiments described above may include a single entity or a plurality of entities, in which some of the corresponding sub-components described above may be omitted or other sub-components may be further included in various embodiments. Alternatively or additionally, some of the components (e.g., the modules or the programs) may be integrated into one entity to perform the same or similar functions performed by each individual corresponding component before the integration. According to various embodiments, operations performed by the module, the programs or other components may be executed sequentially, in parallel, iteratively or heuristically, or at least some operations may be executed in different order, omitted, or additionally include other operations.

Although a few embodiments of the disclosure have been illustrated and described above, the disclosure is not limited to the specific embodiments described above, and various modifications may be made by a person having ordinary skill in the art without departing from the scope of the disclosure as claimed in the claims. Further, such modifications should not be individually understood from the technical spirit or prospect of the disclosure.

What is claimed is:

1. An analog equalizer network apparatus for wideband light-of-sight (LoS)-multi-input multi-output (MIMO) processing, the apparatus comprising:
a power distributor configured to distribute a first input signal received through a receiving antenna of a wideband LoS-MIMO network to a first path from a first input terminal to a first output terminal, and distribute a second input signal received through the receiving antenna to a second path from a second input terminal to the first output terminal;
a first delay line located on the first path, and configured to delay the first input signal distributed to the first path;
a second phase shifter located on the second path and configured to shift a phase of the second input signal distributed to the second path; and
a power combiner configured to combine the delayed first input signal and the phase-shifted second input signal to perform channel separation.

2. The apparatus of claim 1, wherein the first delay line comprises a variable delay line for a variable delay, and a fixed delay line for a fixed delay.

3. The apparatus of claim 2, wherein the second phase shifter comprises a variable phase shifter for a variable phase shift, or a fixed phase shifter for a fixed phase shift.

4. The apparatus of claim 3, wherein, to enable the channel separation for all frequencies in the wideband LoS-MIMO network, a phase of a normalized channel matrix comprises a component linearly dependent on the frequency and a constant component.

5. The apparatus of claim 4, wherein the linearly dependent component is implemented by the first delay line, and the constant component is implemented by the second phase shifter.

6. The apparatus of claim 3, further comprising a second delay line for the wideband LoS-MIMO processing of an asymmetrical array, wherein
the second delay line is located on the second path and configured to delay the phase-shifted second input signal so as to compensate for a time delay caused by a receiving array, and
the power combiner combines the delayed first input signal and the delayed second input signal.

7. The apparatus of claim 3, further comprising a first phase shifter located in front of the first delay line on the first path, and configured to shift a phase of the first input signal distributed to the first path and transmit the phase-shifted first input signal to the first delay line.

8. The apparatus of claim 3, further comprising a first variable attenuator located in front of the first delay line on the first path, and configured to variably attenuate the first input signal distributed to the first path and transmit the variably attenuated first input signal to the first delay line.

9. The apparatus of claim 8, further comprising a second variable attenuator located behind the second phase shifter on the second path, and configured to variably attenuate the second input signal, the phase of which has been shifted in the second phase shifter, and transmit the phase-shifted and variably-attenuated second input signal to the power combiner.

10. The apparatus of claim 9, further comprising a first phase shifter located in front of the first variable attenuator on the first path, and configured to shift the phase of the first input signal distributed to the first path and transmit the phase-shifted first input signal to the first variable attenuator.

11. The apparatus of claim 3, further comprising:
a first variable amplifier located in front of the first delay line on the first path, and configured to variably amplify the first input signal distributed to the first path and transmit the variably amplified first input signal to the first delay line; and
a second variable amplifier located behind the second phase shifter on the second path, and configured to variably amplify the second input signal, the phase of which has been shifted in the second phase shifter, and transmit the phase-shifted and variably-amplified second input signal to the power combiner.

12. An analog equalizer network apparatus for wideband light-of-sight (LoS)-multi-input multi-output (MIMO) processing, the apparatus comprising:
a plurality of analog equalizer networks configured to perform channel separation of input signals received through receiving antennas of N×N LOS MIMO networks, wherein
each of the plurality of analog equalizer networks comprises:
a power distributor configured to distribute a first input signal received through the receiving antenna of the wideband LoS-MIMO network to a first path from a first input terminal to a first output terminal, and distribute a second input signal received through the receiving antenna to a second path from a second input terminal to the first output terminal;
a first delay line located on the first path, and configured to delay the first input signal distributed to the first path;
a second phase shifter located on the second path and configured to shift a phase of the second input signal distributed to the second path; and
a power combiner configured to combine the delayed first input signal and the phase-shifted second input signal to perform channel separation.

13. The apparatus of claim 12, wherein the first delay line comprises a variable delay line for a variable delay, and a fixed delay line for a fixed delay.

14. The apparatus of claim 13, wherein the second phase shifter comprises a variable phase shifter for a variable phase shift, or a fixed phase shifter for a fixed phase shift.

15. The apparatus of claim 14, further comprising a second delay line for the wideband LoS-MIMO processing of an asymmetrical array, wherein
the second delay line is located on the second path and configured to delay the phase-shifted second input signal so as to compensate for a time delay caused by a receiving array, and
the power combiner combines the delayed first input signal and the delayed second input signal.

16. The apparatus of claim 14, further comprising a first phase shifter located in front of the first delay line on the first path, and configured to shift a phase of the first input signal distributed to the first path and transmit the phase-shifted first input signal to the first delay line

17. The apparatus of claim 14, further comprising a first variable attenuator located in front of the first delay line on the first path, and configured to variably attenuate the first input signal distributed to the first path and transmit the variably attenuated first input signal to the first delay line.

18. The apparatus of claim 17, further comprising a second variable attenuator located behind the second phase shifter on the second path, and configured to variably attenuate the second input signal, the phase of which has been shifted in the second phase shifter, and transmit the phase-shifted and variably-attenuated second input signal to the power combiner.

19. The apparatus of claim 18, further comprising a first phase shifter located in front of the first variable attenuator on the first path, and configured to shift the phase of the first input signal distributed to the first path and transmit the phase-shifted first input signal to the first variable attenuator.

20. The apparatus of claim 14, further comprising:
a first variable amplifier located in front of the first delay line on the first path, and configured to variably amplify the first input signal distributed to the first path and transmit the variably amplified first input signal to the first delay line; and
a second variable amplifier located behind the second phase shifter on the second path, and configured to variably amplify the second input signal, the phase of which has been shifted in the second phase shifter, and transmit the phase-shifted and variably-amplified second input signal to the power combiner.
